(19) United States
(12) Patent Application Publication
(10) Pub. No.: US 2026/0070786 A1
(43) Pub. Date: Mar. 12, 2026

(54) MODIFIED METAL OXIDE PARTICLE MATERIAL AND METHOD FOR PRODUCING SAME

(71) Applicant: ADMATECHS CO., LTD., Miyoshi-shi (JP)

(72) Inventors: Kenta TAKEI, Miyoshi-shi (JP); Miki MATSUDA, Miyoshi-shi (JP); Keisuke KURITA, Miyoshi-shi (JP); Yusuke WATANABE, Miyoshi-shi (JP); Yuri AOKI, Miyoshi-shi (JP)

(73) Assignee: ADMATECHS CO., LTD., Miyoshi-shi (JP)

(21) Appl. No.: 19/386,454

(22) Filed: Nov. 12, 2025

Related U.S. Application Data
(63) Continuation of application No. PCT/JP2023/018022, filed on May 12, 2023.

(51) Int. Cl. C01B 13/14

(52) U.S. Cl. CPC C01B 13/145; C01P 2004/61; C01P 2004/62

(57) ABSTRACT

An object is to provide a modified metal oxide particle material that maintains high dispersibility even when the amount of modifying material is small. The material includes (i) a metal oxide particle material having, on its surface, a functional group other than a phenyl group; and (ii) a modifying material composed of a silicon-containing compound having a phenyl group, adhered to the surface of the metal oxide particle material. The value C/H, calculated from the carbon content C (mass %) and the specific surface area H (m\hat{ }2 per g), decreases by ≥0.001, ≥0.01, or ≥0.03 and <0.1 after washing with methyl ethyl ketone. The grind gauge is ≤20 μm. The post-wash C/H is ≤0.07.

### CROSS REFERENCE TO RELATED APPLICATIONS

The present application is a Continuation Application of International Application No. PCT/JP2023/018022, filed on May 12, 2023, which is incorporated herein by reference.

### TECHNICAL FIELD

The present disclosure relates to a modified metal oxide particle material that is dispersed in a resin material or an organic solvent and used, and a method for producing the modified metal oxide particle material.

### BACKGROUND ART

To date, a resin composition in which a filler material formed of metal oxide is dispersed in a resin material has been used for general purposes. Mechanical characteristics of the resin composition and a cured product of the resin composition are enhanced by dispersing the filler material formed of metal oxide (Patent Literature 1 or the like). The filler material is required to be uniformly dispersed in such a resin composition. In order to obtain such a resin composition, the filler material is dispersed directly in a resin material, or a slurry composition in which the filler material is dispersed in an organic solvent is produced, and the slurry composition is then mixed in a resin material, to produce the resin composition.

The present inventors have developed a technique for enhancing dispersibility by adhering a modifying material to a surface of a surface-treated metal oxide particle material, in order to attain the aforementioned object (Patent Literature 2).

### CITATION LIST

### Patent Literature

Patent Literature 1: JP6603777 (B)
Patent Literature 2: WO2021/210628

### SUMMARY OF INVENTION

### Technical Problem

In the technique disclosed in Patent Literature 2, high dispersibility is achieved in a resin material. However, reduction of an amount of a modifier is advantageous in, for example, enhancing electric characteristics. Therefore, an amount of a modifier adhered to a surface of a particle material is preferably small depending on the application, and an amount of a modifying material has been required to be reduced.

The present disclosure has been completed in view of the aforementioned circumstances, and an object to be attained by the present disclosure is to provide a modified metal oxide particle material as a metal oxide particle material that has high dispersibility even when an amount of a modifying material is small, and a method for producing the modified metal oxide particle material.

### Solution to Problem

In order to attain the aforementioned object, the present inventors have conducted thorough studies. As a result, the present inventors have found that the effect in Patent Literature 2 that, by previously forming a modified metal oxide particle material in which a modifying material formed of a silicon-containing compound having a phenyl group is put in a metal oxide particle material, and dispersing the modified metal oxide particle material in this state in a resin material or an organic solvent, the resin material or the organic solvent easily enters the metal oxide particle material to enhance dispersibility, is sufficiently exhibited even in a case where an amount of the modifying material to be adhered is made small by inhibiting a reaction progressing in the modifying material. If a reaction progresses in the modifying material, the performance intrinsic to the modifying material is not sufficiently exhibited.

Specifically, the present inventors have found that, by reducing a heating temperature and a heating time at which a modifying material is adhered to a surface of a metal oxide particle material, a reaction in the modifying material is inhibited, and the effect is sufficiently exhibited with a small amount of the modifying material, and have completed the following technique of the present disclosure.
(1) That is, a modified metal oxide particle material according to the present disclosure for attaining the aforementioned object includes:
a metal oxide particle material having, on a surface, a functional group other than a phenyl group; and
a modifying material formed of a silicon-containing compound having a phenyl group, the modifying material being adhered to the surface of the metal oxide particle material, in which
a value of C/H calculated from a carbon content C (% by mass) and a surface area H (m²) per 1 g is reduced by 0.001 or more and less than 0.1 after washing with methyl ethyl ketone,
a grind gauge indicates 20 μm or less, and
the value of C/H after the washing is 0.07 or less.

The modified metal oxide particle material of the present disclosure is allowed to have one or more of configurations according to the following (2) to (8).
(2) (Dielectric dissipation factor)/H is preferably 0.0005 or less.
(3) The modified metal oxide particle material is prepared by adhering, to the metal oxide particle material, a modifying material solution in which the modifying material is dissolved or dispersed in A mL of a solvent, and thereafter heating and drying an obtained product at T° C. for m minutes (such that T×m÷A is 150 or less).
(4) The silicon-containing compound of the modifying material is a silane compound having a phenyl group, or a condensation product of a silane compound having a phenyl group and a silane compound having a hydrocarbon group that binds directly to Si.
(5) The silane compound having a phenyl group is represented by ((C₆H₅)X)ₙ—Si-OR₍₄₋ₙ₎, and the silane compound having the hydrocarbon group is represented by Rn—Si—OR(4-n),
   (in which X represents direct binding, —(CH2)q-, or —O—; q represents an integer of 0 to 3; n represents an integer selected from 1 to 3 independently for each molecule; and R represents a C1 to C3 hydrocarbon group selected independently for each functional group).
(6) The silicon-containing compound of the modifying material is represented by general formula (1): R1-O—(SiZ1Z2O)ₙ—(SiZ3Z4O)ₘ—R2,
   (in the formula, Z1 represents (C6H5)X—; Z2 to Z4 each independently represent (C6H5)X—, a C1 to C3 hydrocarbon group, a C1 to C3 alkoxy group, or -Or-(CH2)p-Ot- that binds to other Z2 to Z4; X represents direct binding, —(CH2)q-, or —O—; n and p each represent an integer of 1 or more; m represents an integer of 0 or more; q represents an integer that is 0 or more and each independently selected; r and t are each independently selected from 0 and 1; and R1 and R2 are each independently selected from a C1 to C3 hydrocarbon group and a C1 to C3 alkoxy group).
(7) The metal oxide particle material is subjected to surface treatment with a silane compound.
(8) A volume average particle diameter is 0.01 μm or more and 5 μm or less.
(9) A method for producing a modified metal oxide particle material according to the present disclosure for attaining the aforementioned object is a method for producing the above-described modified metal oxide particle material, and the method includes:
a surface treatment step of subjecting a metal oxide particle material to surface treatment with a silane compound to produce a surface-treated metal oxide particle material;
a dispersion step of dispersing a silicon-containing compound having a phenyl group in a dispersion slurry in which the surface-treated metal oxide particle material is dispersed in A mL of a dispersion medium; and
a drying step of drying the dispersion medium by heating and drying at T° C. for m minutes after the dispersion step, and thus adhering a modifying material formed of the silicon-containing compound to a surface of the surface-treated metal oxide particle material, to produce a modified metal oxide particle material, such that T×m÷A is 150 or less.

### Advantageous Effects of Invention

The modified metal oxide particle material of the present disclosure has an enhanced dispersibility into a resin material or an organic solvent by previously putting the modifying material in the metal oxide particle material. A reaction is inhibited in the put modifying material, and the effect is thus highly exhibited with a small amount of the modifying material.

### DESCRIPTION OF EMBODIMENTS

A modified metal oxide particle material and a method for producing the modified metal oxide particle material according to the present disclosure will be described below in detail based on an embodiment. The modified metal oxide particle material of the present embodiment is a material that is suitably used as a filler material to be dispersed in a resin material or an organic solvent. Particularly, the modified metal oxide particle material is preferably provided in a dry state. Preferably, by dispersing the modified metal oxide particle material in a resin material and an organic solvent when used, a modifying material adhered to a surface of the modified metal oxide particle material is transferred into the organic solvent or the like to exhibit the effect.

### (Modified Metal Oxide Particle Material)

The modified metal oxide particle material of the present embodiment has a surface-treated metal oxide particle material and a modifying material. The modified metal oxide particle material preferably has high sphericity. Preferably, the sphericity is, for example, 0.8 or more, 0.9 or more, 0.95 or more, or 0.99 or more.

The surface-treated metal oxide particle material is a metal oxide particle material having been subjected to surface treatment. Examples of the metal oxide particle material include silica, alumina, zirconia, titania, and composite oxides thereof. Examples of the composite oxide include calcium titanate, barium titanate, and zeolite. Although the particle diameter of the metal oxide particle material is not particularly limited, the metal oxide particle material preferably has a particle size distribution suitable as the filler material. The particle diameter is, for example, 0.01 μm or more and 5 μm or less. As the lower limit value, for example, 0.01 μm, 0.05 μm, 0.1 μm, 0.3 μm, and 0.5 μm are adopted. As the upper limit value, for example, 2 μm, 3 μm, 4 μm, and 5 μm are adopted. The upper limit value and the lower limit value are discretionarily combined.

The surface-treated metal oxide particle material has a functional group other than a phenyl group on the surface. Examples of the functional group other than a phenyl group include carbon-containing functional groups such as an alkyl group, a vinyl group, an epoxy group, a methacryl group, an amino group, and an isocyanate group. Although a method for introducing such a functional group is not particularly limited, a silane compound having such a functional group is used to subject the metal oxide particle material to surface treatment, thereby introducing the functional group. For example, the silane compound is brought, as it is, into contact with the surface of the metal oxide particle material, or a solution is produced by using a certain solvent to bring the silane compound into contact with the surface of the metal oxide particle material. Thereafter, the obtained product is left as it is or heated until the reaction is completed.

In a case where the functional group is introduced by using a silane compound, reaction with and binding to OH groups on the surface of the metal oxide particle material is assumed to occur, and an amount of the OH groups removed by the reaction is preferably 50% or more, more preferably 70% or more, even more preferably 90% or more, and particularly preferably 100%. Phenyl groups may be partially introduced as long as the functional groups other than a phenyl group are introduced.

The modifying material is a material adhered to the surface of the surface-treated metal oxide particle material. The adhesion means that physical adsorption is predominant while an adhered amount by chemical reaction is small. Whether or not physical adsorption is predominant is determined according to whether or not 30% or more (preferably 50% or more and more preferably 70% or more) by mass of the modifying material is eliminated when the modifying material is dispersed in an organic solvent.

A part of the modifying material may react with the surface of the surface-treated metal oxide particle material. For example, the modifying material may react in such a range that a value of C/H calculated from a surface area H (m²) per 1 g of the surface-treated metal oxide particle material, and a carbon content C (% by mass) after washing is 0.07 or less, and may react in such a range that the value of C/H is 0.06 or less, 0.05 or less, 0.04 or less, 0.03 or less, or 0.02 or less. Washing is performed under a washing condition that 5 g of the modified metal oxide particle material is put into 35 mL of methyl ethyl ketone (MEK), and ultrasound is applied for five minutes. A kind and an amount of the modifying material are set such that a value of C/H calculated from a carbon content C (% by mass) and a surface area H (m²) per 1 g of the surface-treated metal oxide particle material is changed between before and after washing with MEK, by 0.001 or more, 0.01 or more, or 0.03 or more, and less than 0.1. The lower limit value is, for example, 0.015, 0.020, 0.025, 0.035, 0.040, or 0.045, and the upper limit value is, for example, 0.090, 0.080, 0.070, or 0.065. The upper limit value and the lower limit value are discretionarily combined. The carbon content C also includes a content of carbon derived from the compound having the functional group which is other than a phenyl group and binds to the surface of the surface-treated metal oxide particle material.

In a case where a silane compound contains one silicon atom, the silane compound preferably has two phenyl groups. For example, the silane compound is diphenyldialkoxysilane. As the alkoxy group, a methoxy group or an ethoxy group is preferable and a methoxy group is particularly preferable. An additive (modifier) having two phenyl groups has high steric hindrance as compared with an additive having one phenyl group, so that dispersibility is enhanced, and reactivity is reduced and the additive is inhibited from firmly binding to the surface of the surface-treated metal oxide particle material.

As the modifying material, a silane compound having a phenyl group, or a condensation product of a silane compound having a phenyl group and a silane compound having a hydrocarbon group that binds directly to Si is adopted. The condensation product is, for example, produced by mixing and reaction of silane compounds each having one silicon atom. For the reaction, a catalyst is preferably added. Examples of the catalyst include alkali and noble metal catalysts such as platinum.

For example, examples of the silane compound having a phenyl group include ((C6H5)X)n-Si—OR(4-n), and examples of the silane compound having a hydrocarbon group include Rn—Si—OR(4-n) (X represents direct binding, —(CH2)q-, or —O—; q represents an integer of 0 to 3; n represents an integer selected from 1 to 3 independently for each molecule; and R represents a C1 to C3 hydrocarbon group selected independently for each functional group). X preferably represents direct binding. For example, diphenyldialkoxysilane is a compound in which X represents direct binding and n is 2.

Furthermore, as a silicon-containing compound of the modifying material, a silicon-containing compound represented by general formula (1): R1-O—(SiZ1Z2O)n-(SiZ3Z4O)m-R2 is adopted (in the formula, Z1 represents (C6H5)X—; Z2 to Z4 each independently represent (C6H5)X—, a C1 to C3 hydrocarbon group, a C1 to C3 alkoxy group, or -Or-(CH2)p-Ot- that binds to other Z2 to Z4; X represents direct binding, —(CH2)q-, or —O—; n and p each represent an integer of 1 or more; m represents an integer of 0 or more; q represents an integer that is 0 or more and each independently selected; r and t are each independently selected from 0 and 1; and R1 and R2 are each independently selected from a C1 to C3 hydrocarbon group and a C1 to C3 alkoxy group).

In the modified metal oxide particle material of the present embodiment, a value of (dielectric dissipation factor)/specific surface area is preferably 0.0005 or less, more preferably 0.0004 or less, and even more preferably 0.0003 or less. A method for measuring the dielectric dissipation factor is based on JIS C 2138 (2007). Specifically, the relative permittivity and the dielectric dissipation factor at 1 GHz were measured by using a Network Analyzer (Product name “E5071C”) manufactured by Keysight Technologies, Inc. and a cavity resonator perturbation method. The measurement was performed in accordance with ASTM D2520 (JIS C 2565 (1992)).

In the modified metal oxide particle material of the present embodiment, a value measured by a grind gauge is 20 μm or less. In the measurement by the grind gauge, 10 g of an epoxy resin (manufactured by NIPPON STEEL Chemical & Material Co., Ltd., model number ZX-1059), 20 g of MEK, and 10 g of the modified metal oxide particle material are stirred by a planetary centrifugal mixer, and the evaluation is thereafter performed by the grind gauge. The evaluation by the grind gauge is performed in accordance with JIS K 56000-2-5. The value measured by the grind gauge represents a value correlating with a particle diameter of an aggregate.

### (Method for Producing Modified Metal Oxide Particle Material)

A method for producing the modified metal oxide particle material according to the present embodiment includes a surface treatment step, a dispersion step, and a drying step.

In the surface treatment step, a metal oxide particle material is subjected to surface treatment with a silane compound, to produce a surface-treated metal oxide particle material. The method for producing the metal oxide particle material is, but is not particularly limited to, a VMC method (vaporized metal combustion method), a melting method, or the like. The metal oxide particle material produced by a VMC method is compact, and has low hydrophilia and excellent electric characteristics. The VMC method is a method for producing a metal oxide particle material by putting and burning particles formed of metal of the metal oxide particle material in flame in an oxidation atmosphere.

In the surface treatment step, a functional group other than a phenyl group is introduced onto the surface. As long as a functional group other than a phenyl group is introduced, a phenyl group may be added and introduced. As a method for introducing the functional group, surface treatment is preferably performed with a silane compound having a functional group to be introduced. The surface treatment is performed by bringing a surface treatment agent having a functional group to be introduced into contact with the surface of the metal oxide particle material. The contact is performed by bringing a surface treatment agent in the form of liquid or gas as it is into contact with the surface of the metal oxide particle material, or by using a solution in which a surface treatment agent is dissolved in a certain solvent. Although an amount of the surface treatment agent is not particularly limited, such an amount that an amount of OH groups on the surface of the metal oxide particle material indicates the above-described residual rate is adopted.

In the dispersion step, the surface-treated metal oxide particle material is dispersed in a dispersion medium to form a dispersion slurry, and a silicon-containing compound is dispersed in the dispersion slurry. The silicon-containing compound and an amount of the silicon-containing compound as described for the modified metal oxide particle material of the above-described embodiment are adopted.

Examples of the dispersion medium of the dispersion slurry include MEK, isopropyl alcohol, propylene glycol monomethyl ether acetate, cyclohexanone, methyl isobutyl ketone, toluene, N-methylpyrrolidone, N-ethylpyrrolidone, and gamma butyrolactone. A content of the surface-treated metal oxide particle material contained in the dispersion slurry is, but is not particularly limited to, about 10% to 80% with respect to the total mass. As the lower limit value, 10%, 30%, and 50% are adopted. As the upper limit value, 60%, 70%, and 80% are adopted. The upper limit value and the lower limit value are discretionarily combined.

For preparing the dispersion slurry and for dispersing the modifying material in the dispersion slurry, a stirring/shearing force may be applied or ultrasound may be applied.

In the drying step, the dispersion medium is removed. A method for removing the dispersion medium is not particularly limited. However, in the method, when a drying time until the dispersion medium is removed is m minutes, a temperature at that time is T° C., and a dispersion medium volume is A mL, T×m÷A is 150 or less, and the upper limit value of T×m÷A is, for example, 140, 130, 120, 110, 100, 90, or 80.

In a case where T×m÷A is the upper limit value or less, a reaction in the modifying material is inhibited from progressing. In a case where progress of the reaction is equivalent to the progress in the case of T×m÷A being the upper limit value or less, a modified metal oxide particle material produced in another method is also considered to be the modified metal oxide particle material of the present embodiment although the modified metal oxide particle material produced in the other method is not considered to be produced in the method for producing the modified metal oxide particle material according to the present embodiment.

The temperature T represents an average value of temperatures of the dispersion slurry during the drying time. The start of the drying time is a time when the temperature T of the dispersion slurry achieves the start temperature or higher after the dispersion slurry has been prepared in the dispersion step. A time when the dispersion medium is determined to have been removed at the end of the drying time is a time when an amount of the dispersion medium becomes 1% by mass or less. After the temperature of the dispersion slurry has become the start temperature or higher, in a case where the temperature of the dispersion slurry becomes lower than the start temperature, a time until the temperature of the dispersion slurry becomes the start temperature or higher again is eliminated from the drying time. The start temperature is 110° C., and 105° C., 100° C., 80° C., 60° C., or 40° C. may be adopted.

A heating method is not limited to a specific method. However, examples of the heating method include a method in which heating is simply performed, and a method in which pressure is reduced simultaneously with the heating. Particularly, in the heating, spray drying using a disc rotor or a pressure nozzle may be adopted, and the spray drying is preferable since the drying time (m minutes) is effectively shortened.

The silicon-containing compound is transformed to the modifying material through the drying. The modifying material may be dissolved in the dispersion medium or may not be dissolved in the dispersion medium. In a case where the silicon-containing compound is dissolved, the modifying material is deposited and formed into particles according to the dispersion medium being dried. In a case where the silicon-containing compound is not dissolved in the dispersion medium, the silicon-containing compound is adhered as it is to the surface of the surface-treated metal oxide particle material.

### EXAMPLES

The modified metal oxide particle material and the method for producing the modified metal oxide particle material according to the present disclosure will be described below in detail based on examples.

### Examples 1 to 7, Comparative Examples 1 to 7

### Preparation of Sample

As the metal oxide particle material, spherical silica or spherical alumina having the particle diameter indicated in Table 1 was used. All of the spherical silica and the spherical alumina were products of ADMATECHS COMPANY LIMITED and produced by a VMC method. The model number of the spherical silica having a volume average particle diameter of 0.3 μm was SO—C1, the model number of the spherical silica having a volume average particle diameter of 0.5 μm was SO—C2, and the model number of the spherical silica having a volume average particle diameter of 2.0 μm was SO—C6. As the spherical alumina having a volume average particle diameter of 2.0 μm, powder in which the model numbers AO-502 and AO-509 were mixed at a mass ratio of 8:2 was used.

KBM-1003 (manufactured by Shin-Etsu Chemical Co., Ltd.: vinyltrimethoxysilane) as a surface treatment agent was added to 100 parts by mass of the metal oxide particle material to perform surface treatment, and the surface-treated metal oxide particle material was obtained. An amount of the surface treatment agent to be added was 1 part by mass for the spherical silica having a volume average particle diameter of 0.3 μm, an amount of the surface treatment agent to be added was 1 part by mass for the spherical silica having a volume average particle diameter of 0.5 μm, and an amount of the surface treatment agent to be added was 0.3 parts by mass for the spherical silica having a volume average particle diameter of 2.0 μm, with respect to 100 parts by mass of the metal oxide particle material. An amount of the surface treatment agent to be added was 0.5 parts by mass in the case of the spherical alumina. Through the reaction with the above-described amounts, an amount of the surface treatment agent per unit surface area was made uniform. A vinyl group was introduced onto the surface of the obtained surface-treated metal oxide particle material (surface treatment step).

A dispersion slurry was prepared by mixing 100 parts by mass of the surface-treated metal oxide particle material and 64.4 parts by mass (80 mL) of methyl ethyl ketone (MEK). A silicon-containing compound (manufactured by Shin-Etsu Chemical Co., Ltd., specified by product No., confirmed in a catalogue for a functional group contained: KBM-202SS represents a monomer in which the functional group is diphenyl, and KR-9218 represents an oligomer in which the functional groups are phenyl and methyl) indicated in Table 1 was added per the surface area (1 m²) of the surface-treated metal oxide particle material contained in the dispersion slurry such that the amount was a C content before washing as indicated in Table 1, and the silicon-containing compound was dispersed for two minutes by CLEARMIX CLM-2.2S: manufactured by M Technique Co., Ltd., (17000 rpm) (dispersion step).

Thereafter, the obtained product was heated at 110° C. for a time (m minutes) indicated in Table 1 and dried (drying step) to obtain powder. The obtained powder was used as a test sample for each of the examples and the comparative examples.

For the test samples of the examples and the comparative examples, a carbon content before washing (C content before washing), a carbon content after washing (C content after washing), a carbon content (C content of material powder) of the surface-treated metal oxide particle material (material powder) before adhesion of the modifying material after washing with MEK, and a dielectric dissipation factor (Df) were measured. A degree of dispersion was also measured by using a grind gauge. Evaluation of a degree of dispersion using a grind gauge is a test based on JIS K 56000-2-5, and a grind gauge value represents a value correlating with a particle diameter of an aggregate. That is, a greater grind gauge value indicates that larger aggregates are generated.

Furthermore, for the test samples of the examples and the comparative examples, a value (Df/SSA) of (dielectric dissipation factor)/(specific surface area), and the temperature (T° C.)×drying time (m minutes)÷dispersion medium volume (A mL) were calculated and indicated in Table 1.

TABLE 1

| | Example | Example | Example | Example | Example | Example | Example |
|---|---|---|---|---|---|---|---|
| | 1 | 2 | 3 | 4 | 5 | 6 | 7 |
| Modifying material | KBM- | KBM- | KBM- | KBM- | KBM- | KR-9218 | KBM- |
| | 202SS | 202SS | 202SS | 202SS | 202SS | | 202SS |
| Functional group | diphenyl | diphenyl | diphenyl | diphenyl | diphenyl | phenyl | diphenyl |
| of modifying | | | | | | and | |
| material | | | | | | methyl | |
| Material | silica | silica | silica | silica | silica | silica | alumina |
| Grind gauge (μm) | 15 | 16 | 19 | 14 | 16 | 8 | 80 |
| Particle diameter | 0.5 | 0.5 | 0.5 | 0.3 | 2.0 | 0.3 | 2.0 |
| (μm) | | | | | | | |
| Specific surface | 5 | 5 | 5 | 11 | 2 | 12 | 2.3 |
| area (m²/g) | | | | | | | |
| C content (%) | 0.5 | 0.5 | 0.5 | 1.0 | 0.2 | 1.0 | 0.4 |
| before washing | | | | | | | |
| C content (%) | 0.2 | 0.2 | 0.2 | 0.5 | 0.1 | 0.3 | 0.1 |
| after washing | | | | | | | |
| Difference (%) in | 0.3 | 0.3 | 0.3 | 0.5 | 0.1 | 0.7 | 0.3 |
| C content between | | | | | | | |
| before and after | | | | | | | |
| washing | | | | | | | |
| Difference | 0.05 | 0.05 | 0.05 | 0.05 | 0.05 | 0.06 | 0.13 |
| (%/(m²/g)) in C | | | | | | | |
| content per | | | | | | | |
| specific surface | | | | | | | |
| area between | | | | | | | |
| before and after | | | | | | | |
| washing | | | | | | | |
| Df | 0.0014 | 0.0014 | 0.0014 | 0.0051 | 0.0002 | 0.0040 | 0.0010 |
| Df/specific | 0.0003 | 0.0003 | 0.0003 | 0.0005 | 0.0001 | 0.0003 | 0.0004 |
| surface area | | | | | | | |
| Drying temperature | 110 | 110 | 110 | 110 | 110 | 110 | 110 |
| (° C.) | | | | | | | |
| Drying time | 10 | 50 | 100 | 10 | 10 | 10 | 10 |
| (minutes) | | | | | | | |
| Dispersion medium | 80 | 80 | 80 | 80 | 80 | 80 | 80 |
| volume (mL) | | | | | | | |
| Temperature × drying | 13.75 | 68.75 | 137.5 | 13.75 | 13.75 | 13.75 | 13.75 |
| time ÷ dispersion | | | | | | | |
| medium volume | | | | | | | |
| | Comp. | Comp. | Comp. | Comp. | Comp. | Comp. | Comp. |
| | Ex. 1 | Ex. 2 | Ex. 3 | Ex. 4 | Ex. 5 | Ex. 6 | Ex. 7 |
| Modifying material | KBM- | KBM- | KBM- | KBM- | KR-9218 | KBM- | KBM- |
| | 202SS | 202SS | 202SS | 202SS | | 202SS | 203SS |
| Functional group of | diphenyl | diphenyl | diphenyl | diphenyl | phenyl | diphenyl | diphenyl |
| modifying material | | | | | and | | |
| | | | | | methyl | | |
| Material | silica | silica | silica | silica | silica | alumina | alumina |
| Grind gauge (μm) | 15 | 25 or | 14 | 16 | 8 | 88 | 100 or |
| | | more | | | | | more |
| Particle diameter | 0.5 | 0.5 | 0.3 | 2.0 | 0.3 | 2.0 | 2.0 |
| (μm) | | | | | | | |
| Specific surface | 5 | 5 | 11 | 2 | 12 | 2.3 | 2.3 |
| area (m²/g) | | | | | | | |
| C content (%) | 1.8 | 0.5 | 1.6 | 0.3 | 2.0 | 1.3 | 0.4 |
| before washing | | | | | | | |
| C content (%) after | 0.2 | 0.2 | 0.4 | 0.1 | 0.3 | 0.1 | 0.1 |
| washing | | | | | | | |
| Difference (%) in C | 1.6 | 0.3 | 1.2 | 0.2 | 1.7 | 1.2 | 0.3 |
| content between | | | | | | | |
| before and after | | | | | | | |
| washing | | | | | | | |
| Difference | 0.29 | 0.05 | 0.11 | 0.11 | 0.15 | 0.53 | 0.13 |
| (%/(m²/g)) in C | | | | | | | |
| content per | | | | | | | |
| specific surface | | | | | | | |
| area between before | | | | | | | |
| and after washing | | | | | | | |
| Df | 0.0032 | 0.0014 | 0.0070 | 0.0012 | 0.0080 | 0.0030 | 1.0030 |
| Df/specific surface | 0.0006 | 0.0003 | 0.0006 | 0.0006 | 0.0007 | 0.0013 | 0.4361 |
| area | | | | | | | |
| Drying temperature | 110 | 110 | 110 | 110 | 110 | 110 | 110 |
| (° C.) | | | | | | | |
| Drying time | 120 | 120 | 120 | 120 | 120 | 120 | 120 |
| (minutes) | | | | | | | |
| Dispersion medium | 80 | 80 | 80 | 80 | 80 | 80 | 80 |
| volume (mL) | | | | | | | |
| Temperature × drying | 165 | 165 | 165 | 165 | 165 | 165 | 165 |
| time ÷ dispersion | | | | | | | |
| medium volume | | | | | | | |

In a case where the spherical silica was used as the metal oxide particle material, the results of Examples 1 to 3 and Comparative example 2 indicate that, in a case where the temperature×drying time-dispersion medium volume (=T×m÷A) was 150 or less, even when an amount of the modifying material to be added was small, the grind gauge value was small and dispersibility was high. Comparative example 2 indicates that, although the reduction of the value of C/H after washing was 0.05 and was thus small, since the heating time was long, the grind gauge indicated 25 μm or more, and aggregation occurred. The result of Comparative example 1 indicates that, under the condition of (T×m÷A) being more than 150, the C content before washing was 1.8% and the C content after washing was 0.2%, and thus, the grind gauge value was not made small, that is, aggregation was not inhibited unless a large amount of the modifying material as compared with the amount in the examples was adhered.

Comparison between Examples 4 and 5 and Comparative examples 3 and 4 indicates that, in a case where the heating was performed for a long time (condition of (T×m÷A) being more than 150), an amount of the modifying material to be added needed to be greater than the amounts in the examples in order to inhibit aggregation (to indicate an equivalent grind gauge value), similarly to Examples 1 to 3 and Comparative example 1, even when the particle diameters were different.

The results of Example 6 and Comparative example 5 indicate that, in a case where the heating was performed for a long time, an amount of the modifying material to be added needed to be greater than the amount in the example in order to inhibit aggregation even when the modifying material having a phenyl group and a methyl group instead of diphenyl as the functional group was used.

Also in a case where the spherical alumina was used as the metal oxide particle material, the same tendency as in the case where the spherical silica was used was found. Specifically, Example 7 indicates that, in a case where the temperature×drying time+dispersion medium volume (=T×m÷A) was 150 or less, even when an amount of the modifying material to be added was small, the grind gauge value was small and dispersibility was high, as compared with Comparative examples 6 and 7.

Furthermore, also when, as in Comparative example 6, an amount of the modifying material to be added was greater than the amount in Example 7, and the heating was thus performed for a long time (condition of (T×m÷A) being more than 150), aggregation was found to be inhibited to a certain degree.

As described above, in a case where (T×m÷A) is 150 or less, even when an amount of the modifying material is small, dispersibility is found to be enhanced.

1. A modified metal oxide particle material comprising:
a metal oxide particle material having, on a surface, a functional group other than a phenyl group; and
a modifying material formed of a silicon-containing compound having a phenyl group, the modifying material being adhered to the surface of the metal oxide particle material, wherein
a value of C/H calculated from a carbon content C (% by mass) and a surface area H (m²) per 1 g is reduced by 0.001 or more and less than 0.1 after washing with methyl ethyl ketone,
a grind gauge indicates 20 μm or less, and
the value of C/H after the washing is 0.07 or less.

2. The modified metal oxide particle material according to claim 1, wherein (dielectric dissipation factor)/H is 0.0005 or less.

3. The modified metal oxide particle material according to claim 1, wherein the modified metal oxide particle material is prepared by adhering, to the metal oxide particle material, a modifying material solution in which the modifying material is dissolved or dispersed in A mL of a solvent, and thereafter heating and drying an obtained product at T° C. for m minutes (such that T×m÷A is 150 or less).

4. The modified metal oxide particle material according to claim 1, wherein the silicon-containing compound of the modifying material is a silane compound having a phenyl group, or a condensation product of a silane compound having a phenyl group and a silane compound having a hydrocarbon group that binds directly to Si.

5. The modified metal oxide particle material according to claim 4, wherein
the silane compound having a phenyl group is represented by ((C₆H₅)X)ₙ—Si—OR₍₄₋ₙ₎, and
the silane compound having the hydrocarbon group is represented by Rn—Si—OR(4-n),
(in which X represents direct binding, —(CH2)q-, or —O—; q represents an integer of 0 to 3; n represents an integer selected from 1 to 3 independently for each molecule; and R represents a C1 to C3 hydrocarbon group selected independently for each functional group).

6. The modified metal oxide particle material according to claim 1, wherein the silicon-containing compound of the modifying material is represented by general formula (1): R1-O—(SiZ1Z2O)ₙ—(SiZ3Z4O)ₘ—R2,
(in the formula, Z1 represents (C6H5)X—; Z2 to Z4 each independently represent (C6H5)X—, a C1 to C3 hydrocarbon group, a C1 to C3 alkoxy group, or -Or-(CH2)p-Ot- that binds to other Z2 to Z4; X represents direct binding, —(CH2)q-, or —O—; n and p each represent an integer of 1 or more; m represents an integer of 0 or more; q represents an integer that is 0 or more and each independently selected; r and t are each independently selected from 0 and 1; and R1 and R2 are each independently selected from a C1 to C3 hydrocarbon group and a C1 to C3 alkoxy group).

7. The modified metal oxide particle material according to claim 1, wherein the metal oxide particle material is subjected to surface treatment with a silane compound.

8. The modified metal oxide particle material according to claim 1, wherein a volume average particle diameter is 0.01 μm or more and 5 μm or less.

9. A method for producing the modified metal oxide particle material according to claim 1, the method comprising:
a surface treatment step of subjecting a metal oxide particle material to surface treatment with a silane compound to produce a surface-treated metal oxide particle material;
a dispersion step of dispersing a silicon-containing compound having a phenyl group in a dispersion slurry in which the surface-treated metal oxide particle material is dispersed in A mL of a dispersion medium; and
a drying step of drying the dispersion medium by heating and drying at T° C. for m minutes after the dispersion step, and thus adhering a modifying material formed of the silicon-containing compound to a surface of the surface-treated metal oxide particle material, to produce a modified metal oxide particle material (such that T×m÷A is 150 or less).

10. A method for producing the modified metal oxide particle material according to claim 2, the method comprising:
a surface treatment step of subjecting a metal oxide particle material to surface treatment with a silane compound to produce a surface-treated metal oxide particle material;
a dispersion step of dispersing a silicon-containing compound having a phenyl group in a dispersion slurry in which the surface-treated metal oxide particle material is dispersed in A mL of a dispersion medium; and
a drying step of drying the dispersion medium by heating and drying at T° C. for m minutes after the dispersion step, and thus adhering a modifying material formed of the silicon-containing compound to a surface of the surface-treated metal oxide particle material, to produce a modified metal oxide particle material (such that T×m÷A is 150 or less).

11. A method for producing the modified metal oxide particle material according to claim 3, the method comprising:
a surface treatment step of subjecting a metal oxide particle material to surface treatment with a silane compound to produce a surface-treated metal oxide particle material;
a dispersion step of dispersing a silicon-containing compound having a phenyl group in a dispersion slurry in which the surface-treated metal oxide particle material is dispersed in A mL of a dispersion medium; and
a drying step of drying the dispersion medium by heating and drying at T° C. for m minutes after the dispersion step, and thus adhering a modifying material formed of the silicon-containing compound to a surface of the surface-treated metal oxide particle material, to produce a modified metal oxide particle material (such that T×m÷A is 150 or less).

12. A method for producing the modified metal oxide particle material according to claim 4, the method comprising:
a surface treatment step of subjecting a metal oxide particle material to surface treatment with a silane compound to produce a surface-treated metal oxide particle material;
a dispersion step of dispersing a silicon-containing compound having a phenyl group in a dispersion slurry in which the surface-treated metal oxide particle material is dispersed in A mL of a dispersion medium; and
a drying step of drying the dispersion medium by heating and drying at T° C. for m minutes after the dispersion step, and thus adhering a modifying material formed of the silicon-containing compound to a surface of the surface-treated metal oxide particle material, to produce a modified metal oxide particle material (such that T×m÷A is 150 or less).

13. A method for producing the modified metal oxide particle material according to claim 5, the method comprising:
a surface treatment step of subjecting a metal oxide particle material to surface treatment with a silane compound to produce a surface-treated metal oxide particle material;
a dispersion step of dispersing a silicon-containing compound having a phenyl group in a dispersion slurry in which the surface-treated metal oxide particle material is dispersed in A mL of a dispersion medium; and
a drying step of drying the dispersion medium by heating and drying at T° C. for m minutes after the dispersion step, and thus adhering a modifying material formed of the silicon-containing compound to a surface of the surface-treated metal oxide particle material, to produce a modified metal oxide particle material (such that T×m÷A is 150 or less).

14. A method for producing the modified metal oxide particle material according to claim 6, the method comprising:
a surface treatment step of subjecting a metal oxide particle material to surface treatment with a silane compound to produce a surface-treated metal oxide particle material;
a dispersion step of dispersing a silicon-containing compound having a phenyl group in a dispersion slurry in which the surface-treated metal oxide particle material is dispersed in A mL of a dispersion medium; and
a drying step of drying the dispersion medium by heating and drying at T° C. for m minutes after the dispersion step, and thus adhering a modifying material formed of the silicon-containing compound to a surface of the surface-treated metal oxide particle material, to produce a modified metal oxide particle material (such that T×m÷A is 150 or less).

15. A method for producing the modified metal oxide particle material according to claim 7, the method comprising:
a surface treatment step of subjecting a metal oxide particle material to surface treatment with a silane compound to produce a surface-treated metal oxide particle material;
a dispersion step of dispersing a silicon-containing compound having a phenyl group in a dispersion slurry in which the surface-treated metal oxide particle material is dispersed in A mL of a dispersion medium; and
a drying step of drying the dispersion medium by heating and drying at T° C. for m minutes after the dispersion step, and thus adhering a modifying material formed of the silicon-containing compound to a surface of the surface-treated metal oxide particle material, to produce a modified metal oxide particle material (such that T×m÷A is 150 or less).

16. A method for producing the modified metal oxide particle material according to claim 8, the method comprising:
a surface treatment step of subjecting a metal oxide particle material to surface treatment with a silane compound to produce a surface-treated metal oxide particle material;
a dispersion step of dispersing a silicon-containing compound having a phenyl group in a dispersion slurry in which the surface-treated metal oxide particle material is dispersed in A mL of a dispersion medium; and
a drying step of drying the dispersion medium by heating and drying at T° C. for m minutes after the dispersion step, and thus adhering a modifying material formed of the silicon-containing compound to a surface of the surface-treated metal oxide particle material, to produce a modified metal oxide particle material (such that T×m÷A is 150 or less).
